(19) United States
(12) Patent Application Publication
(10) Pub. No.: US 2026/0006401 A1
(43) Pub. Date: Jan. 1, 2026

(54) SPATIAL AUDIO USING A SINGLE AUDIO DEVICE

(71) Applicant: QUALCOMM Incorporated, San Diego, CA (US)

(72) Inventor: Nan ZHANG, Beijing (CN)

(21) Appl. No.: 18/880,771

(22) PCT Filed: Aug. 25, 2022
(86) PCT No.: PCT/CN2022/114880

§ 371 Date: Jan. 2, 2025

(51) Int. Cl. H04S 7/00; H04S 1/00

(52) U.S. Cl. CPC H04S 7/308; H04S 1/007; H04S 7/304; H04S 2400/03; H04S 2400/11

(57) ABSTRACT

Disclosed are systems, apparatuses, processes, and computer-readable media to. According to some aspects, a method of processing audio data may include obtaining, at a computing device, sensing information from an audio device outputting a spatial audio stream for a user, wherein the audio device includes a first audio output device and a second audio output device; determining, based on the sensing information, that the second audio output device is not in use; modifying the spatial audio stream based on determining that the second audio output device is not in use and a head pose of the user to create a modified spatial audio stream; and providing the modified spatial audio stream to the first audio output device.

### CROSS-REFERENCE TO RELATED APPLICATIONS

This application for Patent is a 371 of international Patent Application PCT/CN2022/114880, filed Aug. 25, 2022, which is hereby incorporated by referenced in its entirety and for all purposes.

### FIELD

In some examples, systems and techniques are described for spatial audio using a single audio device.

### BACKGROUND

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include mobile devices, game devices, entertainment systems, information systems, virtual reality systems, model and simulation systems, and so on. These systems may employ a combination of hardware and software technologies to support the processing, storage, generation, manipulation, and rendition of multimedia information, for example, client devices, capture devices, storage devices, communication networks, computer systems, and display devices.

In some cases, portable devices, such as headphones, can be used with a wide variety of multimedia systems. Truly wireless listening devices do not include a cable and instead, wirelessly receive a stream of audio data from a wireless audio source, have become popular and can be used in multimedia systems and can output spatial audio to provide an immersive experience.

### SUMMARY

In some examples, systems and techniques are described for spatial audio using a single audio device. The systems and techniques can improve spatial audio by extending spatial audio to be used with a monophonic channel and reduce power consumption by omitting various filtering operations.

According to at least one example, a method is provided for generating a spatial audio stream for a single audio device. The method includes: obtaining, at a computing device, sensing information from an audio device outputting a spatial audio stream for a user, wherein the audio device includes a first audio output device and a second audio output device; determining, based on the sensing information, that the second audio output device is not in use; modifying the spatial audio stream based on determining that the second audio output device is not in use and a head pose of the user to create a modified spatial audio stream; and providing the modified spatial audio stream to the first audio output device.

In another example, an apparatus for device function is provided that includes at least one memory and at least one processor coupled to the at least one memory. The at least one processor is configured to: obtain sensing information from an audio device that is outputting a spatial audio stream for a user, wherein the audio device includes a first audio output device and a second audio output device; determine, based on the sensing information, that the second audio output device is not in use; modify the spatial audio stream based on determining that the second audio output device is not in use and a head pose of the user to create a modified spatial audio stream; and provide the modified spatial audio stream to the first audio output device.

In another example, a non-transitory computer-readable medium is provided that has stored thereon instructions that, when executed by one or more processors, cause the one or more processors to: obtain sensing information from an audio device that is outputting a spatial audio stream for a user, wherein the audio device includes a first audio output device and a second audio output device; determine, based on the sensing information, that the second audio output device is not in use; modify the spatial audio stream based on determining that the second audio output device is not in use and a head pose of the user to create a modified spatial audio stream; and provide the modified spatial audio stream to the first audio output device.

In another example, an apparatus for device function is provided. The apparatus includes: means for obtaining sensing information from an audio device outputting a spatial audio stream for a user, wherein the audio device includes a first audio output device and a second audio output device; means for determining, based on the sensing information, that the second audio output device is not in use; means for modifying the spatial audio stream based on determining that the second audio output device is not in use and a head pose of the user to create a modified spatial audio stream; and means for providing the modified spatial audio stream to the first audio output device.

In some aspects, the apparatus is, is part of, and/or includes a wearable device, an extended reality (XR) device (e.g., a virtual reality (VR) device, an augmented reality (AR) device, or a mixed reality (MR) device), a head-mounted device (HMD) device, a wireless communication device, a mobile device (e.g., a mobile telephone and/or mobile handset and/or so-called “smartphone” or another mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example wireless audio output device 100 in accordance with some aspects of the disclosure.

FIG. 2 illustrates a conceptual diagram of a truly wireless (TWS) audio output system 200 that may be configured to use a single audio output device according to various aspects of the disclosure.

FIG. 3 is a conceptual diagram that illustrates a person that consumes spatial audio in accordance with some aspects of the disclosure.

FIG. 4 illustrates a conceptual example of an application executed by a host device in accordance with some aspects of the disclosure.

FIGS. 5A, 5B, 5C, and 5D illustrate examples of spatial audio systems and methods of determining when an audio output device is not in use, in accordance with some aspects of the disclosure.

FIG. 6 is a flowchart illustrating an example of a method for processing audio, in accordance with certain aspects of the present disclosure.

FIG. 7 shows a block diagram of an example host device that is configured to generate a spatial audio stream for a single audio device according to some aspects.

FIG. 8 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Spatial audio creates a three-dimensional (3D) virtual auditory space that allows a user wearing an auxiliary device with inertial sensors to pinpoint where a sound source is located in the 3D virtual auditory space, while watching a movie, playing a video game, or interacting with augmented reality (AR) or virtual reality (VR) content on a source device (e.g., a tablet computer). Spatial Audio allows a person listening to audio (referred to herein as a listerner) to pinpoint a source of audio within a 3D environment. Spatial audio includes channel-based, binaural, or object-based audio technology, protocol, standard, format, or any other audio rendering concept or technology that provides a 3D virtual auditory space.

Audio devices that enable spatial audio must include various sensors, such as an inertia measurement unit (IMU), to detect motion of the listener that may modify an audio stream, and determine a head pose of the listener, and then modify audio sources within the audio stream. Truly wireless (TWS) earbuds and headphones have recently implemented spatial audio features to allow an immersive experience for the listener when both earbuds or headphones are attached to the listener.

Spatial audio naturally requires left and right audio devices to provide a stereophonic audio stream (e.g., a left audio stream and a right audio stream), and spatial audio may be discontinued when one of the left and right audio devices is detached from the listener. However, there are instances in which a listener may want to hear spatial audio when a single audio device is in use. For example, many people have limited ability to hear in a single ear, or a single audio device may be charging. In another example, a person may want to monitor external audio by only having a single audio device providing audio to monitor for external audio cues such as a doorbell, a door opening, and so forth. In some cases, different people may be connected to a single audio device, such as a first person who listens to the left audio channel and a second person who listens to the right audio channel.

In some aspects, systems, apparatuses, processes (also referred to as methods), and computer-readable media (collectively referred to herein as “systems and techniques”) are described for spatial audio using a single audio device. For instance, an electronic device can obtain sensing information from an audio device including a first audio output device and a second audio output device. The audio device may output a spatial audio stream for a user. In some aspects, the audio device may be a pair of wireless earbuds that can provide stereophonic sound to the listener, with the first audio output device including one earbud and the second audio output device including a second earbud. In other examples, the audio device may be headphones or an XR device (e.g., a virtual reality (VR) device, an augmented reality (AR) device, etc.) that includes earbuds or headphones. The electronic device can determine, based on the sensing information, that the second audio output device is not in use. For example, the sensing information can identify or indicate to the electronic device that a distance from a wireless earbud (e.g., a left earbud or a right earbud) to a person is greater than a threshold distance (e.g., 5 centimeters), and based on the sensing information, the electronic device can determine that the wireless earbud is not in use. The electronic device can modify a spatial audio stream based on determining that the second audio output device is not in use. The electronic device provide the modified spatial audio stream to the first audio output device.

In one illustrative aspect, the electronic device can modify spatial audio filtering based on a single audio output device being in use (e.g., the first audio output device from the example above). In some cases, filtering that is related to timing differences and channel differences can be omitted (or not performed) when modifying the spatial audio stream. The electronic device may provide a spatial audio stream that is monophonic and can be used by a single audio output device. In another illustrative aspect, the disclosed methods, systems, and techniques can be used to enable multiple listeners that each uses a single audio output device with a monophonic spatial audio stream.

Additional details and aspects of the present disclosure are described in more detail below with respect to the figures.

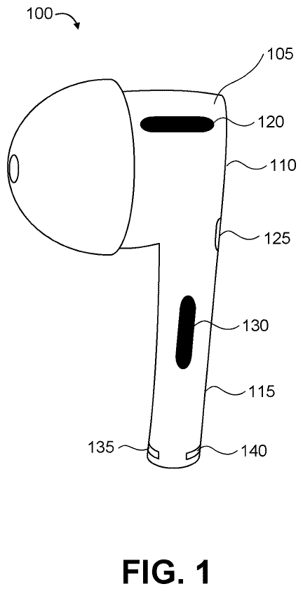

FIG. 1 illustrates an example wireless audio output device 100 in accordance with some aspects of the disclosure. The wireless audio output device 100 provides a single channel of audio, either a left channel or a right channel, and can be operated with another wireless audio output device (not shown) to provide two channels of audio (e.g., a left channel and a right channel). Each

According to some embodiments, each wireless audio output device 100 can include a housing 105 formed of a body 110 and a stem 115 extending from body 110. In some aspects, the housing 105 can be formed of a monolithic outer structure such as a molded plastic. The body 110 can include an internally facing microphone 120 and an externally facing microphone 125. Externally facing microphone 125 can be positioned within an opening defined by portions of body 110 and stem 115. By extending into both body 110 and stem 115, microphone 125 can be large enough to receive sounds from a broader area proximate to the listener. In some embodiments, the housing 105 can define an acoustic port that can direct sound from an internal audio driver out of housing 105 and into a listener's ear canal. In other embodiments, wireless audio output device 100 can include a deformable ear tip that can be inserted into a listener's ear canal enabling the wireless listening devices to be configured as in-ear hearing devices.

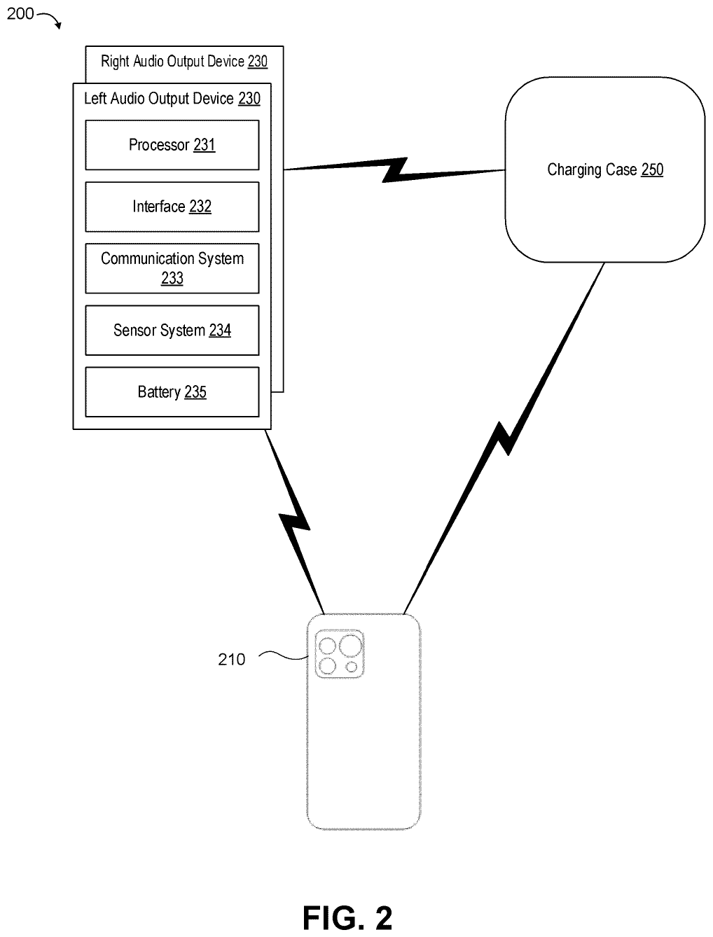

In one example, the stem 115 has a substantially cylindrical construction along with a planar region 130 that does not follow the curvature of the cylindrical construction. The planar region 130 can indicate an area where the wireless listening device is capable of receiving listener input. For instance, in some embodiments listener input can be inputted by squeezing stem 115 at planar region 130. In some embodiments, planar region 130 can include a touch-sensitive surface in addition to or instead of pressure sensing capabilities, that allow a listener to input touch commands, such as contact gestures. Stem 115 can also include electrical contact 135 and electrical contact 140 for contacting with corresponding electrical contacts in the charging case (e.g., charging case 250 in FIG. 2).

The wireless audio output device 100 can include several features that can enable the devices to be comfortably worn by a listener for extended periods of time and even all day. The housing 105 can be shaped and sized to fit securely between the tragus and anti-tragus of a listener's ear so that the portable listening device is not prone to falling out of the ear even when a listener is exercising or otherwise actively moving. Its functionality can also enable wireless audio output device 100 to provide an audio interface to the host device (e.g., host device 210) so that the listener may not need to utilize a graphical interface of the host device. The audio output device 100 can be sufficiently sophisticated to enable the listener to perform day-to-day operations from the host device solely through interactions with a wireless audio output device 100. This can create further independence from the host device by not requiring the listener to physically interact with, and/or look at the display screen of, the host device, especially when the functionality of wireless audio output device 100 is combined with the voice control capabilities of the host device. Thus, wireless audio output device 100 can enable a truly wireless and a truly hands-free experience for the listener.

The wireless audio output device 100 can also include various components that cannot be visually perceived. For example, the wireless audio output device 100 can include at least one sensor for detecting various aspects of the device. Illustrative aspects of the device include, the state of the device (e.g., whether the wireless audio output device 100 is attached to a person), pose information related to a listener, biometric information (e.g., the temperature of the listener), and so forth. At least one of the sensors of the wireless audio output device 100 can be configured to output pose information that identifies an orientation of the listener's head with respect to a neutral position (e.g., a neutral head position). The pose information may be used by a host device and the host device may be configured to alter an audio stream presented to the wireless audio output device 100 to provide a spatial audio stream that provides a 3D virtual auditory space

FIG. 2 illustrates a conceptual diagram of a TWS audio output system 200 that may be configured to use a single audio output device according to various aspects of the disclosure. The TWS audio output system 200 includes a host device 210, a pair of audio output devices 230 (e.g., a left audio output device 230 and a right audio output device 230), and a charging case 250.

The host device 210 is depicted in FIG. 2 as a mobile communication device (e.g., a smartphone), but can be any electronic device that can transmit audio data to a wireless audio output device (e.g., the wireless audio output device 100. Other, non-limiting examples of suitable host devices 210 include a laptop computer, a desktop computer, a tablet computer, a smartwatch, an audio system, a video player, and the like.

In some aspects, each audio output device 230 can receive and generate sound to provide an enhanced user interface for the host device 210. The audio output device 230 can include a processor 231 that executes computer-readable instructions stored in a memory (not shown) for performing a plurality of functions for the audio output device 230. In some examples, the processor 231 can be one or more suitable computing devices, such as microprocessors, computer processing units (CPUs), digital signal processing units (DSPs), field programmable gate arrays (FPGAs), application-specific integrated circuits (ASICs) and the like.

The processor 231 can be operatively coupled to an interface 232, a communication system 233, and a sensor system 234 for the audio output device 230 to perform one or more functions. For instance, the interface 232 can include a driver (e.g., speaker) for outputting sound to a user, one or more microphones for inputting sound from the environment or the user, one or more light emitting diodes (LEDs) for providing visual notifications to a user, a pressure sensor or a touch sensor (e.g., a resistive or capacitive touch sensor) for receiving user input, and/or any other suitable input or output device. The communication system 233 can include wireless and wired communication components for enabling the audio output device 230 to send and receive data/commands from the host device 210. For example, the communication system 233 can include circuitry that the audio output device 230 to communicate with host device 210 over wireless link 260, which be implemented by a standard (e.g., Bluetooth, WiFi Direct, Zigbee, etc.) or a proprietary communication link. The communication system 233 can also enable the audio output device 230 to wirelessly communicate with the charging case 250 via a wireless link.

In some aspects, the sensor system 234 can include proximity sensors (e.g., optical sensors, capacitive sensors, radar, etc.), accelerometers, microphones, and any other type of sensor that can measure a parameter of an external entity and/or environment.

The audio output device 230 may also include a battery 235, (e.g., a suitable energy storage device such as a lithium ion battery, etc.) that is capable of storing energy and discharging stored energy to operate the audio output device 230. The discharged energy can be used to power the electrical components of audio output device 230. The battery 235 can be a rechargeable battery and permit charging as needed to replenish stored energy. For instance, the battery 238 can be coupled to battery charging circuitry (not shown) that is operatively coupled to receive power from a charging case interface (not shown). The case interface may include electrical contacts to electrically couple with the audio output device 230 to the charging case 250. In some aspects, power can be received by the audio output device 230 from charging case 250 via the electrical contacts within the charging case. In some aspects, the audio output device 230 may be changed via an inductive communication interface via a wireless power receiving coil within the charging case 250.

The charging case 250 can include a battery (not shown) that can store and discharge energy to power circuitry to recharge the battery 235 of the audio output device 230. As mentioned above, the audio output device 230 may include electrical contacts (e.g., electrical contact 135 and electrical contact 140) that can transfer power to the audio output device 230 through a wired electrical connection between contacts in the charging case. In some cases, the charging case 250 may be configured to facilitate a setup of a wireless connection between the host device 210 and the audio output device 230.

The charging case 250 can also include a processor (not shown) and a communication system (not shown). The processor can be one or more processors, ASICs, FPGAs, microprocessors, and the like for operating the charging case 250. The processor can be coupled to an earbud interface and can control the charging function of the charging case 250 to recharge batteries 235 of the audio output device 230, and the processor can also be coupled to a communication system for operating the interactive functionalities of the charging case with other devices, including the audio output device 230. In one example, the communication system of the charging case 250 includes a Bluetooth component, or any other suitable wireless communication component, that wirelessly sends and receives data with the communication system 233 of the audio output device 230. Towards this end, the charging case 250 and each audio output device 230 can include an antenna formed of a conductive body to send and receive electromagnetic signals.

The charging case 250 can also include a user interface (e.g., a button, a speaker, a light emitter such as an LED, etc.) that can be operatively coupled to the processor to alert a user of various notifications. For example, the user interface can include a speaker that can emit audible noise capable of being heard by a user and/or one or more LEDs or similar lights that can emit a light that can be seen by a user. For example, the charging case 250 may output audio or light to indicate whether at least one audio output device 230 is being charged by charging case 250 or to indicate whether the case battery is low on energy or being charged.

The host device 210 is configured to connect to the audio output device 230 and provide audio information. The audio output device 230 may also provide information in some contexts, such as whether the audio output device 230 is attached to a listener. In some cases, the host device 210 can include a processor (not shown) that is coupled to a battery (not shown) and a host memory bank (not shown) containing lines of code executable by the host computing system (not shown) for operating the host device 210. The host device 210 can also include a host sensor system, e.g., accelerometer, gyroscope, light sensor, and the like, for allowing host device 210 to sense the environment, and a host user interface system, e.g., display, speaker, buttons, touch screen, and the like, for outputting information to and receiving input from a user. Additionally, the host device 210 can also include a communication system for allowing host device 210 to send and/or receive data, e.g., wireless fidelity (WiFi), long term evolution (LTE), code division multiple access (CDMA), global system for mobiles (GSM), Bluetooth, and the like. The communication system of the host device 210 can also communicate with the communication system 233 via a wireless communication link so that the host device 210 can send audio data to the audio output device 230 to output sound, and receive data from the audio output device 230 to receive user inputs. The communication link can be any suitable wireless communication line such as Bluetooth connection. By enabling communication between the host device 210 and the audio output device 230, the audio output device 230 can enhance the user interface of host device 210.

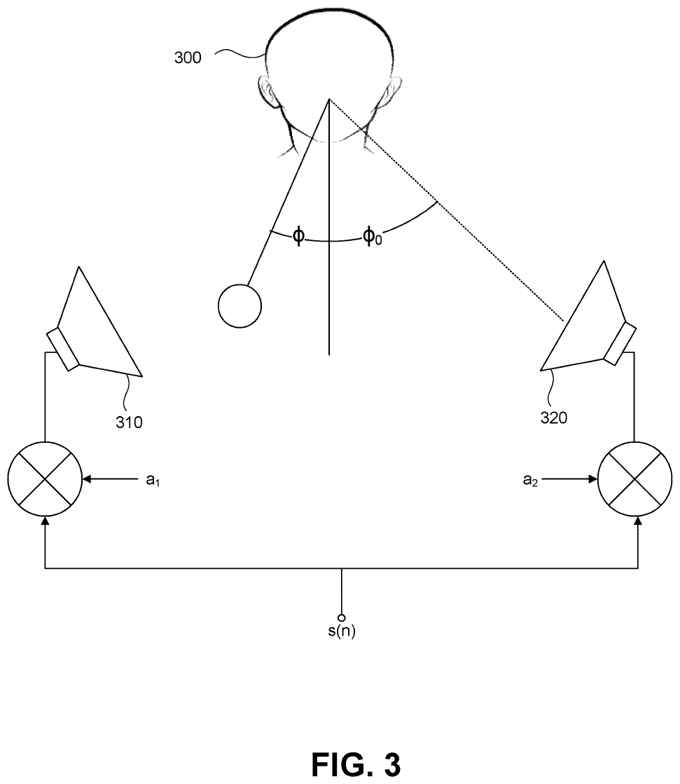

FIG. 3 is a conceptual diagram that illustrates a listener 300 that consumes spatial audio in accordance with some aspects of the disclosure. In some aspects, FIG. 3 illustrates an example playback system for spatial audio is the stereo loud-speaker setup, which includes an audio output device 310 and an audio output device 320, which are placed in front on the left and right sides of the listener 300. Although FIG. 3 illustrates loudspeakers, the audio output devices can also be headphones or earbuds (e.g., the wireless audio output device 100). Typically, the loudspeakers 302 are placed on a circle at angles of −30° and 30°, and the width of the auditory spatial image that is perceived when listening to such a stereo playback system is limited approximately to the area between and behind the two loudspeakers.

In some aspects, stereo loudspeaker playback depends on the perceptual phenomenon of summing localization, an auditory event can be made to appear anywhere between a loudspeaker pair in front of a listener by controlling the inter-channel time difference (ICTD) and/or inter-channel level difference (ICLD). For example, when only introducing amplitude differences (e.g., ICLD) between a loudspeaker pair, it is possible to create phase differences between the ears, or an interaural time difference (ITD) that is similar to those occurring in natural listening.

In some aspects, the ICTD is the phase difference is the time difference between an audio source with respect to the left channel and the right channel, and the ICLD is the intensity difference between the audio source with respect to the left channel and the right channel. For example, an object to the left of a listener 300 will have a higher intensity (e.g., a power spectral density (PSD)) on the left channel that is output by an audio output device 310 positioned to the left of the listener (e.g., that is provided to a left audio output device 230) as compared to the right channel (e.g., that is provided to a right audio output device 230). In some aspects, the left channel is output by an audio output device 310 that is positioned to the left of a neutral position of the listener and the right channel is output by an audio output device 320 that is positioned to the right of a neutral position of the listener. For example, the audio output device 310 and the

In some aspects, the ICTD introduces a phase delay and the ICLD introduces an intensity difference. For example, sources located on the left side result in a stronger signal on the left side of the listener as compared to the right side. In other words, the ICLD of two audio output devices is based on the source angle @. When these audio signals are played back over an audio output system (e.g., loudspeakers, audio output devices 230 in FIG. 2, etc.) an auditory event will appear at an angle Φ′ which is related to the original source angle Φ.

In some aspects, spatial audio for stereo audio output systems can be generated by mixing a number of separately available source signals (e.g. multitrack recording). Conventionally, ICLD, which may also be referred to as amplitude panning, was implemented in the audio stream. The concept of amplitude panning is visualized in FIG. 3. A sound source s(n) is reproduced using the audio output device 310 and the audio output device 320 with signal scale factors ai and az. When amplitude panning is applied, the perceived direction of an auditory event approximately follows the stereophonic law of sines, as identified by Equation 1 below.

$$\frac{sin ( Φ )}{sin ( {Φ}_{0} )} = \frac{{a}_{1} - {a}_{2}}{{a}_{1} + {a}_{2}} \qquad ( Equation 1 )$$

where 0° <Φ₀<90° is the angle between the forward axis and the two loudspeakers, Φ is the corresponding angle of the auditory event, and a₁ and a₂ are scale factors that determine the ICLD.

In some aspects, the stereophonic law of tangents improves the head model as compared to the stereophonic law of sines in different listening conditions. In some aspects, the panning laws are only an approximation since the perceived auditory event direction Φ also depends on signal properties such as frequency and signal bandwidth. To that end, spatial audio streams generally implement various filters, such as ICLD filters and ICTD filters to create a spatial audio stream.

Spatial audio can also be reproduced by a different technique referred to as delay panning, which uses ICTD to create spatial audio. Delay panning which was conventionally difficult to reproduce in analog systems and is a primary reason why ICTD panning was conventionally not used. In some cases, ICLD may be preferable to use over ICTD because ICLD is more robust for non-ideal conditions. In some aspects, ICTD may be used when ideal conditions are present, such as when the user is wearing headphones.

Modern approaches to spatial audio may implement spatial audio using a head-related transfer function (HTRF), ICLD, ICTD, and inter-channel coherence (ICC) to create a superior effect. In some aspects, HTRF transforms audio based on how the audio is perceived by a human ear, and ICC is a relationship of the left channel with respect to the right channel. When a listener is wearing an audio output device, such as headphones or earbuds, the audio output device may be configured to identify the head pose of the listener to identify their orientation. HTRF, ICLD, ICC and ICTD filters can be applied to the audio stream to create a spatial audio stream that changes how a listener aurally perceives the sounds. In some cases, the head pose can be provided to a host device (e.g., host device 210) and an audio stream that is generated based on an application or function being executed in the host device can be modified to create a spatial audio stream. In some cases, the audio stream can include positional information associated with objects within the application or function (e.g., a listener playing a 3D game), and the host device can modify audio produced by the objects based on the head pose of the listener 300 with respect to the position of those objects.

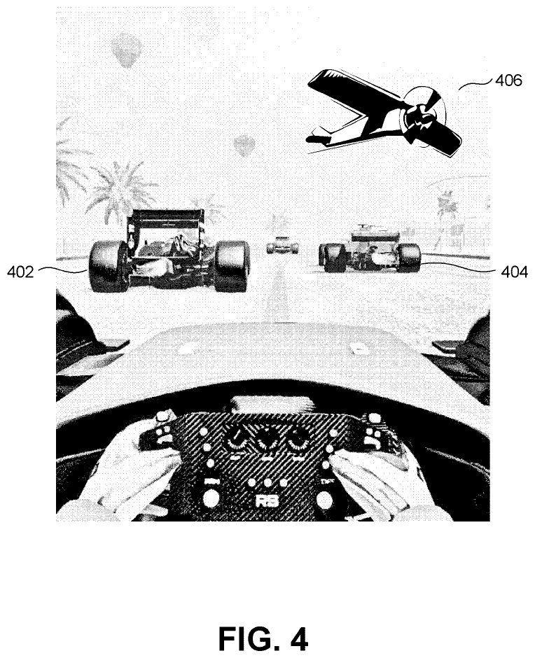

FIG. 4 illustrates a conceptual example of an application executed by a host device in accordance with some aspects of the disclosure. In some aspects, a 3D application is illustrated to depict spatial audio that can be presented by a host device (e.g., host device 210).

In the illustrative example of FIG. 4, the application can be a 3D game (e.g., in VR that is presented by a head-mounted device) for simulating a race. Audio generated by a plurality of objects within the 3D game may include position information. For example, audio from a first car 402 will include information that identifies the position of the first car 402 as ahead and to the left of a user of the host device, and audio from a second car 404 will include information that identifies the position of the second car 404 as ahead and to the right of the user of the host device. In this example, a plane 406 may fly over the scene and the audio produced by the plane 406 may include information of its position with respect to the user of the host device (e.g., the listener).

In some aspects, the user of the host device (e.g., the listener) may be consuming the audio with an audio output device capable of determining the head pose of the user. In that case, the audio produced by the first car 402, second car 404, and the plane 406 may be rendered (e.g., mixed) into a stereo track based on the head pose of the user to provide a spatial audio experience. As described above, HTRF, ICLD, ICTD, ICC, and other effects can be applied to the audio sources based on the position of the object within the application.

For example, when the user changes their head position, the audio produced by each of the first car 402, second car 404, and the plane 406 will change with respect to the head pose of the user. The host device may mix the audio produced by each of the first car 402, second car 404, and the plane 406 based on the head pose of the user into a stereo audio stream that provides a spatial effect and provides a left channel audio stream to a left audio output device and a right channel audio stream to a right audio output device.

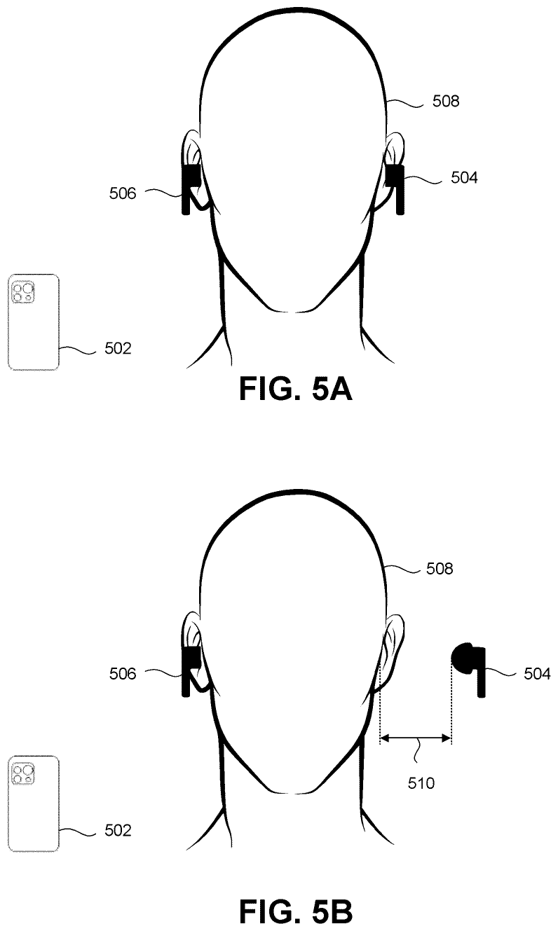

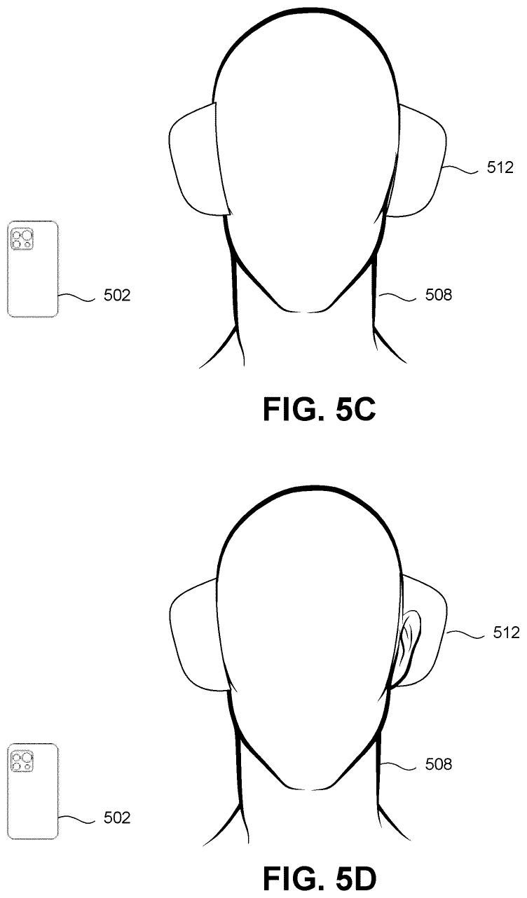

FIGS. 5A, 5B, 5C, and 5D illustrate examples of spatial audio systems and methods of determining when an audio output device is not in use, in accordance with some aspects of the disclosure. FIG. 5A illustrates a host device 502 to provide spatial audio to a left audio output device 504 and a right audio output device 506 to a listener 508 over a wireless communication link.

FIG. 5B illustrates that the listener 508 removes the left audio output device 504 from their ear. The left audio output device 504 includes at least one sensor that is configured to detect when the listener 508 inserts or removes the left audio output device 504 from their ear. For example, the left audio output device 504 can include a proximity sensor that detects that a distance 510 from the left audio output device 504 to the listener's head is greater than a threshold (e.g., 10 centimeters).

In response to detecting that the left audio output device 504 has been inserted or removed, the left audio output device 504 may determine that the left audio output device 504 is either in use (e.g., if the distance is less than the threshold) or no longer in use (e.g., if the distance is greater than the threshold). The left audio output device 504 may send a message to the host device 502 that indicates whether the left audio output device 504 is in use or not. In one example, the message can indicate that the left audio output device 504 is offline or will be transitioning into an offline state. In some commercially available products, the host device 502 may discontinue a spatial stream based on detecting that one of the audio output devices is not in use.

In some aspects, the host device 502 may be configured to detect that a single audio output device is being used by the listener 508 and may provide a spatial audio stream configured for that single audio output device that provides a single audio channel (e.g., a monophonic audio channel).

In one illustrative aspect, the host device 502 is configured to determine whether a source (e.g., an application executing on the host device) includes position information. For example, a music playback application that is providing a stereophonic audio track, may not include position information. In another example, a VR game may provide an audio stream from objects within the VR game that identifies the position of those objects within the VR game. The host device 502 may be configured to process the audio differently based on whether the audio includes the position information or is conventional stereophonic audio.

In some aspects, if the audio does not include position information (e.g., stereophonic audio), the host device may mix the left and right channels from the source into a monophonic audio stream and assign a default position to the monophonic audio stream within a 3D space. The host device may then apply an ICLD filter to the monophonic audio stream based on the head pose of the user and the default position (e.g., 0° from a neutral head position) to yield the spatial audio stream. In this illustrative aspect, any ICTD information and ICC information are not used in the creation of the spatial audio stream. For example, ICTD filtering and ICC filtering to create the spatial stream is omitted. Further, binaural cue filtering is also omitted from the creation of the spatial audio stream.

In some other aspects, if the audio includes position information (e.g., audio from a 3D game or other application), the host device may obtain position information associated with objects that produce audio, and apply an ICLD filter to each object that is producing audio. The host device may omit any ICTD filter and ICC filter used to create the spatial stream is omitted. Further, binaural cue filtering may also be omitted from the creation of the spatial audio stream. An example of binaural cue filtering can be a game runtime sound, such as a gun that is fired in the game and binaural cue filtering outputs the gunshot from a position that can be ascertained by the wearer of the audio device. Another example is a game runtime voice such as an enemy speaking and binaural cue filtering outputs the speech so that the wearer can ascertain a position of the speaking. In another example, the application can be an XR music video and the singer in the music video is moving positions and the binaural cue filtering can change the singer's voice based on the singer's location and the user's head position. After the ICLD filtering, the host is configured to determine a sound scaling factor to apply to each object based on the head pose of the listener and mix the audio stream into a spatial audio stream.

In this illustrative example, the spatial audio stream may be a single channel of audio that will be provided to the audio output device that is active and providing audio to the listener. For example, if the listener removes an audio output device from their left ear, the spatial audio stream may include a right channel and may omit a left channel.

FIG. 5C illustrates another example of a spatial audio system based on a host device 502 that is providing spatial audio to an audio output device 512 that is configured to output stereo audio, such as headphones. As illustrated in FIG. 5C, the audio output device 512 covers both ears of the listener 508. However, the audio output device 512 may acoustically isolate the listener 508 so that the listener 508 cannot perceive other sounds, such as a doorbell. As illustrated in FIG. 5D, the listener 508 may configure the audio output device 512 to cover a single ear to allow the listener 508 to perceive other aural cues. In this case, the audio output device 512 can include a sensor that may identify that the left audio output channel is not in use.

In some aspects, the host device 502 can be configured to receive information from the audio output device 512 that indicates only a single channel of the spatial audio stream is being listened to (e.g., consumed by) the listener 508 and the host device may provide a spatial audio stream configured for that single channel. As noted above, a spatial audio stream for a single channel can continue to provide an immersive experience that is desired by the listener 508.

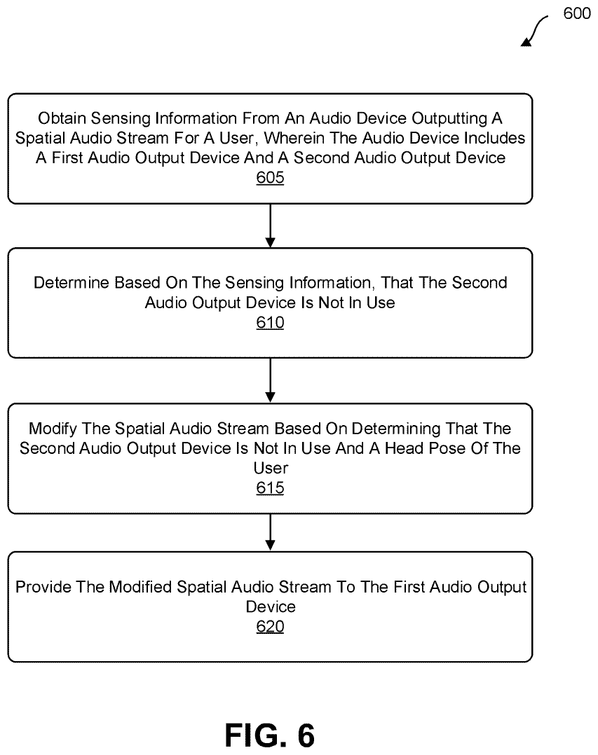

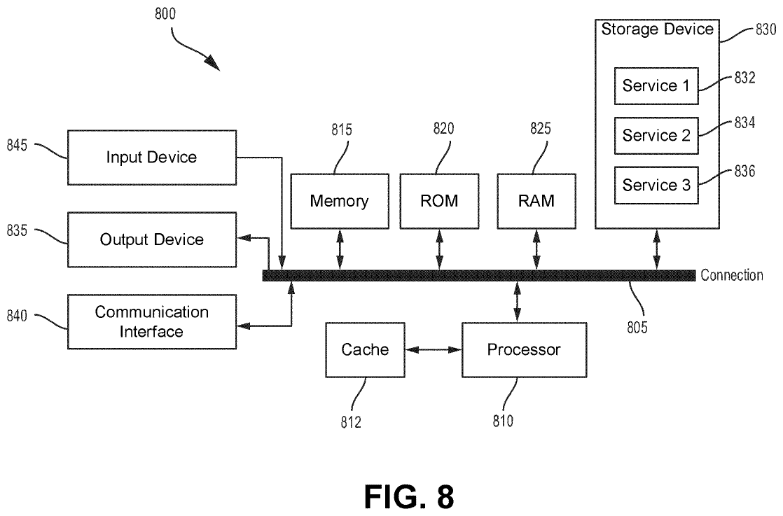

FIG. 6 is a flowchart illustrating an example of a method 600 for processing audio, in accordance with certain aspects of the present disclosure. The method 600 can be performed by a computing device that is configured to provide an audio stream, such as a mobile wireless communication device, an extended reality (XR) device (e.g., a VR device, AR device, MR device, etc.), a network-connected wearable device (e.g., a network-connected watch), a vehicle or component or system of a vehicle, a laptop, a tablet, or another computing device. In one illustrative example, the computing system 800 described below with respect to FIG. 8 can be configured to perform all or part of the method 600.

At block 605, the computing system may obtain sensing information from an audio device that is outputting a spatial audio stream for a user, wherein the audio device includes a first audio output device and a second audio output device. In one illustrative aspect, the audio device can be a pair of headphones, or can be a TWS earphones. The sensing information can indicate the second audio output device is decoupled from the user, the first audio output device, or the computing device. For example, the second audio output device can be a single wireless earphone of associated with a pair of wireless earphones. In another example, the single audio output device can be configured to connect to the computing system in a number of ways, such as a parent-child relationship associated with the pair of wireless earphones, or each wireless earphone can connect to the computing system.

The second audio output device can include various sensors, such as a proximity sensor and a pressure sensor, and provide the sensing information to the computing system. For example, the computing system may obtain the sensing information by receiving the sensing information from a proximity sensor of the second audio output device. In another aspect, the computing system may obtain the sensing information by receiving the sensing information from a pressure sensor of the first audio output device or the second audio output device. In another example, the audio device can be headphones can detect rotation of the headphone and determine that the rotation indicates that one headphone is not positioned over a user's ear.

At block 610, the computing system may determine, based on the sensing information, that the second audio output device is not in use. In some aspects, the computing system may detect, based on the sensing information, decoupling of the second audio output device from the user, the first audio output device, or the computing device. For example, the second audio output device can be disposed in the user's ear canal the sensing information can indicate that the wearer has removed the earphone from the ear canal. In another illustrative aspect, the first audio output device and the second audio output device may have a parent-child relationship, and the first audio output device can provide information to the computing system that the second audio output device is disconnected or in a standby state. In another illustrative aspect, the computing system can determine that a distance between the second audio output device and a head of the user is greater than a threshold distance.

In some other aspects, the computing system can determine a signal strength of a signal from the audio device, and determine that the second audio output device is separated from a head of the user based on the signal strength. For example, the audio device can output a signal for measuring a distance, and a measured value of the signal can indicate that the audio device is separated from a head of the user. In some other aspects, the computing system may use an ML model to identify a number of parameters to indicate that the second audio output device should be disabled. In another illustrative aspect, the determining that the first audio output device is not in use comprises receiving a message from the first audio output device or the second audio output device indicating that the first audio output device or the second audio output device is not in use. For example, a TWS earbud can be removed from a user's ear canal and the TWS earbud can detect and report removal to the computing device.

At block 615, the computing system may modify the spatial audio stream based on determining that the second audio output device is not in use and a head pose of the user to create a modified spatial audio stream. In one illustrative aspect of block 615, the computing system may obtain motion information related to motion of the user from at least the first audio output device. For example, the first audio device can include a motion sensor that tracks a position of a wearer's head.

The computing system can modify the spatial audio stream at block 615 based on determining that the second audio output device is not in use and a head pose of the user. In one aspect, a source of audio associated with the spatial audio stream provides position information associated with one or more objects configured to produce audio, such as a game or a VR simulator. For example, the computing system may obtain the position information associated with each object of the one or more objects. For example, the position information can be associated with an object emitting sound in a game, such as a location of a car in a racing game, or an alert from sensor in a flight simulator.

The computing system at block 615 further may apply at least one spatial filter to each object of the one or more objects and mix audio associated with each object of the one or more objects into the spatial audio stream. To apply the spatial filter, the computing system may determine the second audio output device corresponds to a left channel or a right channel, determine an angle associated an object based on determining the second audio output device corresponds to the left channel or the right channel, and determine a sound scaling factor based on the angle associated with the object, an inter-channel level difference of the object with respect to the left channel and the right channel, and the head pose of the user. In this aspect, inter-channel time difference information and inter-channel coherence information are omitted from modifying of the spatial audio stream.

In another illustrative aspect of block 615, a source of audio associated with the spatial audio stream does not provide position information associated with one or more objects configured to produce audio. For example, the source of audio can be an audio stream or a video file that does not include position information. In this aspect, to modify the spatial audio stream, the computing system may mix left and right channels from the source of audio into a monophonic audio stream, assign a default position to the monophonic audio stream, and apply an inter-channel level difference filter to the monophonic audio stream based on the head pose of the user and the default position to generate the spatial audio stream. The inter-channel time difference information and inter-channel coherence information may be omitted from the modifying of the spatial audio stream.

In another illustrative aspect of block 615, when the source provides the position information, the computing system, to modify of the spatial audio stream, may obtain the position information associated with each object that produces audio from the one or more objects, exclude at least one binaural cue filter, exclude at least one filter associated with an inter-channel time difference or an inter-channel coherence, apply an inter-channel level difference filter to each object that produces audio from the one or more objects, and mix audio associated with each object that produces audio from the one or more objects into the spatial audio stream. In this aspect, the computing system may, to apply the inter-channel level difference filter to an object that produces audio, identify whether the second audio output device corresponds to a left channel or a right channel, determine an angle associated the object based on the second audio output device corresponding to the left channel or the right channel, and determine a sound scaling factor based on the angle associated with the object, an inter-channel level difference of the object with respect to the left channel and the right channel, and the head pose of the user.

In another illustrative aspect of block 615, when the source does not provide the position information, the computing system, to modify the spatial audio stream, may mix left and right channels from the source into the spatial audio stream, assign a default position to the spatial audio stream, excluding at least one binaural cue filter, exclude at least one filter associated with an inter-channel time difference or an inter-channel coherence, and apply an inter-channel level difference filter the spatial audio stream based on the head pose of the user and the default position

At block 620, the computing system may provide the modified spatial audio stream to the first audio output device.

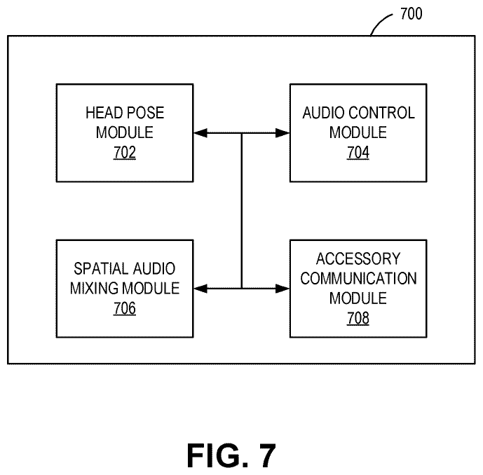

FIG. 7 shows a block diagram of an example host device 700 that is configured to generate a spatial audio stream for a single audio device according to some aspects. In some aspects, the host device 700 is configured to perform one or more of the methods described above.

The host device 700 may include a head pose module 702, an audio control module 704, a spatial audio mixing module 706, and an accessory communication module 708. Portions of one or more of the modules 702, 704, 706, and 708 may be implemented at least in part in hardware or firmware. For example, the accessory communication module 708 may be implemented at least in part by one or more modems (for example, a Bluetooth modem). In some aspects, at least some of the modules 702, 704, 706, and 708 are implemented at least in part as software stored in a memory. For example, portions of one or more of the modules 702, 704, 706, and 708 can be implemented as non-transitory instructions (or “code”) executable by at least one processor to perform the functions or operations of the respective module.

The head pose module 702 may be configured to receive information related to the head pose of the user. For example, a wireless audio output device can detect the head pose information of the user with an IMU and transmit the head pose information to the host device 700.

The audio control module 704 is configured to control audio output by one or more audio sources, such as an application. The audio control module 704 may be configured to determine if the audio output includes position information associated with the audio source. The audio control module 704 can also receive information provided from the wireless audio output device that indicates the state of that wireless audio output device, such as whether the wireless audio output device is in use, or will be offline.

The spatial audio mixing module 706 is configured to receive audio streams and any position information and mix the audio streams based on the state of the audio output device. For example, when a single audio output device is reproducing a single channel of audio, such as when a left audio output device is not attached to the user, the spatial audio mixing module 706 may be configured to control the spatial audio generation as described above. For example, the spatial audio mixing module 706 may be configured to omit ICC filtering, ICTD filtering, and binaural cue filtering.

The accessory communication module 708 is configured to send and receive messages from the audio output devices and may be configured to provide the spatial audio stream to at least one audio output device that is providing audio. In some cases, the accessory communication module 708 may be configured related to wireless communication, but the accessory communication module 708 may also communicate with an audio output device that is electrically connected to the host device 700.

In some examples, the processes described herein (e.g., method 600, and/or other process described herein) may be performed by a computing device or apparatus. In one example, the method 600 can be performed by a computing device having a computing architecture of the computing system 800 shown in FIG. 8.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the method 600. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The method 600 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The method 600 and/or other methods or processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 800 includes at least one processing unit (CPU or processor) 810 and connection 805 that couples various system components including system memory 815, such as ROM 820 and RAM 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method of processing audio data, comprising: obtaining, at a computing device, sensing information from an audio device outputting a spatial audio stream for a user, wherein the audio device includes a first audio output device and a second audio output device; determining, based on the sensing information, that the second audio output device is not in use; modifying the spatial audio stream based on determining that the second audio output device is not in use and a head pose of the user to create a modified spatial audio stream; and providing the modified spatial audio stream to the first audio output device.

Aspect 2: The method of Aspect 1, further comprising: obtaining motion information related to motion of the user from at least the first audio output device; and determining the head pose of the user based on the motion information.

Aspect 3: The method of any of Aspects 1 to 2, wherein the sensing information indicates that the second audio output device is decoupled from the user, the first audio output device, or the computing device, and further comprising: detecting, based on the sensing information, decoupling of the second audio output device from the user, the first audio output device, or the computing device.

Aspect 4: The method of any of Aspects 1 to 3, wherein obtaining the sensing information includes receiving the sensing information from a proximity sensor of the second audio output device.

Aspect 5: The method of any of Aspects 1 to 4, wherein obtaining the sensing information includes receiving the sensing information from a pressure sensor of the first audio output device or the second audio output device.

Aspect 6: The method of any of Aspects 1 to 5, wherein obtaining the sensing information includes receiving the sensing information from the first audio output device or the second audio output device.

Aspect 7: The method of any of Aspects 1 to 6, wherein determining that the second audio output device is not in use comprises: determining that a distance between the second audio output device and a head of the user is greater than a threshold distance.

Aspect 8: The method of any of Aspects 1 to 7, wherein determining that the second audio output device is not in use comprises: determining a signal strength of a signal from the audio device; and determining that the second audio output device is separated from a head of the user based on the signal strength.

Aspect 9: The method of any of Aspects 1 to 8, wherein determining that the first audio output device or the second audio output device is not in use comprises: receiving, at the computing device, a message from the first audio output device or the second audio output device indicating that the first audio output device or the second audio output device is not in use.

Aspect 10: The method of any of Aspects 1 to 9, wherein a source of audio associated with the spatial audio stream provides position information associated with one or more objects configured to produce audio, and wherein modifying the spatial audio stream comprises: obtaining the position information associated with each object of the one or more objects; applying at least one spatial filter to each object of the one or more objects; and mixing audio associated with each object of the one or more objects into the spatial audio stream.

Aspect 11: The method of any of Aspects 1 to 10, wherein applying the at least one spatial filter to an object of the one or more objects comprises: determining the second audio output device corresponds to a left channel or a right channel; determining an angle associated an object based on determining the second audio output device corresponds to the left channel or the right channel; and determining a sound scaling factor based on the angle associated with the object, an inter-channel level difference of the object with respect to the left channel and the right channel, and the head pose of the user.

Aspect 12: The method of any of Aspects 1 to 11, wherein inter-channel time difference information and inter-channel coherence information are omitted from modifying of the spatial audio stream.

Aspect 13: The method of any of Aspects 1 to 12, wherein a source of audio associated with the spatial audio stream does not provide position information associated with one or more objects configured to produce audio, and wherein modifying the spatial audio stream comprises: mixing left and right channels from the source of audio into a monophonic audio stream; assigning a default position to the monophonic audio stream; and applying an inter-channel level difference filter to the monophonic audio stream based on the head pose of the user and the default position to generate the spatial audio stream.

Aspect 14: The method of any of Aspects 1 to 13, wherein inter-channel time difference information and inter-channel coherence information are omitted from the modifying of the spatial audio stream.

Aspect 15: The method of any of Aspects 1 to 14, wherein, when the source provides the position information, modifying of the spatial audio stream comprises: obtaining the position information associated with each object that produces audio from the one or more objects; excluding at least one binaural cue filter; excluding at least one filter associated with an inter-channel time difference or an inter-channel coherence; applying an inter-channel level difference filter to each object that produces audio from the one or more objects; and mixing audio associated with each object that produces audio from the one or more objects into the spatial audio stream.

Aspect 16: The method of any of Aspects 1 to 15, wherein applying the inter-channel level difference filter to an object that produces audio comprises: identifying whether the second audio output device corresponds to a left channel or a right channel; determining an angle associated the object based on the second audio output device corresponding to the left channel or the right channel; and determining a sound scaling factor based on the angle associated with the object, an inter-channel level difference of the object with respect to the left channel and the right channel, and the head pose of the user.

Aspect 17: The method of any of Aspects 1 to 16, wherein, when the source does not provide the position information, modifying of the spatial audio stream comprises: mixing left and right channels from the source into the spatial audio stream; assigning a default position to the spatial audio stream; excluding at least one binaural cue filter; excluding at least one filter associated with an inter-channel time difference or an inter-channel coherence; and applying an inter-channel level difference filter the spatial audio stream based on the head pose of the user and the default position.

Aspect 18: An apparatus including at least one memory (e.g., implemented in circuitry) and at least one processor (or multiple processors) coupled to the memory. The at least one processor (or processors) is configured to: obtain sensing information from an audio device outputting a spatial audio stream for a user, wherein the audio device includes a first audio output device and a second audio output device; determine, based on the sensing information, that the second audio output device is not in use; modify the spatial audio stream based on determining that the second audio output device is not in use and a head pose of the user to create a modified spatial audio stream; and provide the modified spatial audio stream to the first audio output device.

Aspect 19: The apparatus of Aspect 18, wherein the at least one processor is configured to: obtain motion information related to motion of the user from at least the first audio output device; and determine the head pose of the user based on the motion information.

Aspect 20: The apparatus of any of Aspects 18 to 19, wherein the at least one processor is configured to: detect, based on the sensing information, decoupling of the second audio output device from the user, the first audio output device, or the apparatus.

Aspect 21: The apparatus of any of Aspects 18 to 20, wherein, to obtain the sensing information, the at least one processor is configured to receive the sensing information from a proximity sensor of the second audio output device.

Aspect 22: The apparatus of any of Aspects 18 to 21, wherein, to obtain the sensing information, the at least one processor is configured to receive the sensing information from a pressure sensor of the first audio output device or the second audio output device.

Aspect 23: The apparatus of any of Aspects 18 to 22, wherein, to obtain the sensing information, the at least one processor is configured to receive the sensing information from the first audio output device or the second audio output device.

Aspect 24: The apparatus of any of Aspects 18 to 23, wherein the at least one processor is configured to: determine that a distance between the second audio output device and a head of the user is greater than a threshold distance.

Aspect 25: The apparatus of any of Aspects 18 to 24, wherein the at least one processor is configured to: determine a signal strength of a signal from the audio device; and determine that the second audio output device is separated from a head of the user based on the signal strength.

Aspect 26: The apparatus of any of Aspects 18 to 25, wherein the at least one processor is configured to: receive a message from the first audio output device or the second audio output device indicating that the first audio output device or the second audio output device is not in use.

Aspect 27: The apparatus of any of Aspects 18 to 26, wherein a source of audio associated with the spatial audio stream provides position information associated with one or more objects configured to produce audio, and wherein, to modify the spatial audio stream, the at least one processor is configured to: obtain the position information associated with each object of the one or more objects; apply at least one spatial filter to each object of the one or more objects; and mix audio associated with each object of the one or more objects into the spatial audio stream.

Aspect 28: The apparatus of any of Aspects 18 to 27, wherein the at least one processor is configured to: determine the second audio output device corresponds to a left channel or a right channel; determine an angle associated an object based on determining the second audio output device corresponds to the left channel or the right channel; and determine a sound scaling factor based on the angle associated with the object, an inter-channel level difference of the object with respect to the left channel and the right channel, and the head pose of the user.

Aspect 29: The apparatus of any of Aspects 18 to 28, wherein inter-channel time difference information and inter-channel coherence information are omitted from modifying of the spatial audio stream.

Aspect 30: The apparatus of any of Aspects 18 to 29, wherein a source of audio associated with the spatial audio stream does not provide position information associated with one or more objects configured to produce audio, and wherein, to modify the spatial audio stream, the at least one processor is configured to: mix left and right channels from the source of audio into a monophonic audio stream; assign a default position to the monophonic audio stream; and apply an inter-channel level difference filter to the monophonic audio stream based on the head pose of the user and the default position to generate the spatial audio stream.

Aspect 31: The apparatus of any of Aspects 18 to 30, wherein inter-channel time difference information and inter-channel coherence information are omitted from the modifying of the spatial audio stream.

Aspect 32: The apparatus of any of Aspects 18 to 31, wherein, to modify the spatial audio stream, the at least one processor is configured to: obtain the position information associated with each object that produces audio from the one or more objects; exclude at least one binaural cue filter; exclude at least one filter associated with an inter-channel time difference or an inter-channel coherence; apply an inter-channel level difference filter to each object that produces audio from the one or more objects; and mix audio associated with each object that produces audio from the one or more objects into the spatial audio stream.

Aspect 33: The apparatus of any of Aspects 18 to 32, wherein the at least one processor is configured to: identify whether the second audio output device corresponds to a left channel or a right channel; determine an angle associated the object based on the second audio output device corresponding to the left channel or the right channel; and determine a sound scaling factor based on the angle associated with the object, an inter-channel level difference of the object with respect to the left channel and the right channel, and the head pose of the user.

Aspect 34: The apparatus of any of Aspects 18 to 33, wherein, to modify the spatial audio stream, the at least one processor is configured to: mix left and right channels from the source into the spatial audio stream; assign a default position to the spatial audio stream; exclude at least one binaural cue filter; exclude at least one filter associated with an inter-channel time difference or an inter-channel coherence; and apply an inter-channel level difference filter the spatial audio stream based on the head pose of the user and the default position.

Aspect 35: A non-transitory computer-readable medium comprising instructions which, when executed by one or more processors, cause the one or more processors to perform operations according to any of Aspects 1 to 34.

Aspect 36: An apparatus comprising means for performing operations according to any of Aspects 1 to 34.

What is claimed is:

1. A method of processing audio data, comprising:
obtaining, at a computing device, sensing information from an audio device outputting a spatial audio stream for a user, wherein the audio device includes a first audio output device and a second audio output device;
determining, based on the sensing information, that the second audio output device is not in use;
modifying the spatial audio stream based on determining that the second audio output device is not in use and a head pose of the user to create a modified spatial audio stream; and
providing the modified spatial audio stream to the first audio output device.

2. The method of claim 1, further comprising:
obtaining motion information related to motion of the user from at least the first audio output device; and
determining the head pose of the user based on the motion information.

3. The method of claim 1, wherein the sensing information indicates that the second audio output device is decoupled from the user, the first audio output device, or the computing device, and further comprising:
detecting, based on the sensing information, decoupling of the second audio output device from the user, the first audio output device, or the computing device.

4. The method of claim 1, wherein obtaining the sensing information includes receiving the sensing information from a proximity sensor of the second audio output device.

5. The method of claim 1, wherein obtaining the sensing information includes receiving the sensing information from a pressure sensor of the first audio output device or the second audio output device.

6. The method of claim 1, wherein obtaining the sensing information includes receiving the sensing information from the first audio output device or the second audio output device.

7. The method of claim 1, wherein determining that the second audio output device is not in use comprises:
determining that a distance between the second audio output device and a head of the user is greater than a threshold distance.

8. The method of claim 1, wherein determining that the second audio output device is not in use comprises:
determining a signal strength of a signal from the audio device; and
determining that the second audio output device is separated from a head of the user based on the signal strength.

9. The method of claim 1, wherein determining that the first audio output device or the second audio output device is not in use comprises:
receiving, at the computing device, a message from the first audio output device or the second audio output device indicating that the first audio output device or the second audio output device is not in use.

10. The method of claim 1, wherein a source of audio associated with the spatial audio stream provides position information associated with one or more objects configured to produce audio, and wherein modifying the spatial audio stream comprises:
obtaining the position information associated with each object of the one or more objects;
applying at least one spatial filter to each object of the one or more objects; and
mixing audio associated with each object of the one or more objects into the spatial audio stream.

11. The method of claim 10, wherein applying the at least one spatial filter to an object of the one or more objects comprises:
determining the second audio output device corresponds to a left channel or a right channel;
determining an angle associated an object based on determining the second audio output device corresponds to the left channel or the right channel; and
determining a sound scaling factor based on the angle associated with the object, an inter-channel level difference of the object with respect to the left channel and the right channel, and the head pose of the user.

12. The method of claim 10, wherein inter-channel time difference information and inter-channel coherence information are omitted from modifying of the spatial audio stream.

13. The method of claim 10, wherein a source of audio associated with the spatial audio stream does not provide position information associated with one or more objects configured to produce audio, and wherein modifying the spatial audio stream comprises:
mixing left and right channels from the source of audio into a monophonic audio stream;
assigning a default position to the monophonic audio stream; and
applying an inter-channel level difference filter to the monophonic audio stream based on the head pose of the user and the default position to generate the spatial audio stream.

14. The method of claim 13, wherein inter-channel time difference information and inter-channel coherence information are omitted from the modifying of the spatial audio stream.

15. An apparatus comprising:
at least one memory; and
at least one processor coupled to at least one memory and configured to:
obtain sensing information from an audio device outputting a spatial audio stream for a user, wherein the audio device includes a first audio output device and a second audio output device;
determine, based on the sensing information, that the second audio output device is not in use;
modify the spatial audio stream based on determining that the second audio output device is not in use and a head pose of the user to create a modified spatial audio stream; and
provide the modified spatial audio stream to the first audio output device.

16. The apparatus of claim 15, wherein the at least one processor is configured to:
obtain motion information related to motion of the user from at least the first audio output device; and
determine the head pose of the user based on the motion information.

17. The apparatus of claim 15, wherein the at least one processor is configured to:
detect, based on the sensing information, decoupling of the second audio output device from the user, the first audio output device, or the apparatus.

18. The apparatus of claim 15, wherein, to obtain the sensing information, the at least one processor is configured to:
receive the sensing information from a proximity sensor of the second audio output device.

19. The apparatus of claim 15, wherein, to obtain the sensing information, the at least one processor is configured to:
receive the sensing information from a pressure sensor of the first audio output device or the second audio output device.

20. The apparatus of claim 15, wherein, to obtain the sensing information, the at least one processor is configured to:
receive the sensing information from the first audio output device or the second audio output device.

21. The apparatus of claim 15, wherein the at least one processor is configured to:
determine that a distance between the second audio output device and a head of the user is greater than a threshold distance.

22. The apparatus of claim 15, wherein the at least one processor is configured to:
determine a signal strength of a signal from the audio device; and
determine that the second audio output device is separated from a head of the user based on the signal strength.

23. The apparatus of claim 15, wherein the at least one processor is configured to:
receive a message from the first audio output device or the second audio output device indicating that the first audio output device or the second audio output device is not in use.

24. The apparatus of claim 15, wherein a source of audio associated with the spatial audio stream provides position information associated with one or more objects configured to produce audio, and wherein, to modify the spatial audio stream, the at least one processor is configured to:
obtain the position information associated with each object of the one or more objects;
apply at least one spatial filter to each object of the one or more objects; and
mix audio associated with each object of the one or more objects into the spatial audio stream.

25. The apparatus of claim 24, wherein the at least one processor is configured to:
determine the second audio output device corresponds to a left channel or a right channel;
determine an angle associated an object based on determining the second audio output device corresponds to the left channel or the right channel; and
determine a sound scaling factor based on the angle associated with the object, an inter-channel level difference of the object with respect to the left channel and the right channel, and the head pose of the user.

26. The apparatus of claim 24, wherein inter-channel time difference information and inter-channel coherence information are omitted from modifying of the spatial audio stream.

27. The apparatus of claim 24, wherein a source of audio associated with the spatial audio stream does not provide position information associated with one or more objects configured to produce audio, and wherein, to modify the spatial audio stream, the at least one processor is configured to:
mix left and right channels from the source of audio into a monophonic audio stream;
assign a default position to the monophonic audio stream; and
apply an inter-channel level difference filter to the monophonic audio stream based on the head pose of the user and the default position to generate the spatial audio stream.

28. The apparatus of claim 27, wherein inter-channel time difference information and inter-channel coherence information are omitted from the modifying of the spatial audio stream.

29. The apparatus of claim 24, wherein, to modify the spatial audio stream, the at least one processor is configured to:
obtain the position information associated with each object that produces audio from the one or more objects;
exclude at least one binaural cue filter; exclude at least one filter associated with an inter-channel time difference or an inter-channel coherence;
apply an inter-channel level difference filter to each object that produces audio from the one or more objects; and
mix audio associated with each object that produces audio from the one or more objects into the spatial audio stream.

30. The apparatus of claim 24, wherein, to modify the spatial audio stream, the at least one processor is configured to:
identify whether the second audio output device corresponds to a left channel or a right channel;
determine an angle associated the object based on the second audio output device corresponding to the left channel or the right channel; and
determine a sound scaling factor based on the angle associated with the object, an inter-channel level difference of the object with respect to the left channel and the right channel, and the head pose of the user.
